(19) United States
(12) Patent Application Publication
(10) Pub. No.: US 2008/0297023 A1
(43) Pub. Date: Dec. 4, 2008

(54) Filter for a plasma display apparatus

(76) Inventor: Cha-Won Hwang, Suwon-si (KR)

Correspondence Address: ROBERT E. BUSHNELL, 1522 K STREET NW, SUITE 300, WASHINGTON, DC, 20005-1202, US

(21) Appl. No.: 12/155,001

(22) Filed: May 28, 2008

(30) Foreign Application Priority Data
May 30, 2007 (KR) 10-2007-0052926

(51) Int. Cl. H01J 5/16; H01J 61/40

(52) U.S. Cl. 313/479; 313/112

(57) ABSTRACT

A filter that can prevent a double image and increase bright room contrast, has a reduced weight and low manufacturing cost, and is easy to manufacture, and a plasma display apparatus employing the filter. The filter includes a base film, a plurality of light absorbing pattern units that are extended on a surface of the base film in predetermined intervals having a stripe shape, blocking electromagnetic waves, and a reflection prevention layer covering the plurality of light absorbing pattern units.

### CLAIM OF PRIORITY

This application makes reference to, incorporates the same herein, and claims all benefits accruing under 35 U.S.C. §119 from an application for FILTER AND DISPLAY APPARATUS HAVING THE SAME, earlier filed in the Korean Intellectual Property Office on May 30, 2007 and there duly assigned Serial No. 10-2007-0052926.

### BACKGROUND OF THE INVENTION

1. Field of the Invention

The present invention relates to a filter and a plasma display apparatus having the filter, and more particularly, to a filter that can increase bright room contrast by increasing transmittance of light emitted inside and blocking light incident from the outside, and can be made lightweight, slim and cost effective for a plasma display apparatus using the filter.

2. Description of the Related Art

Plasma display apparatuses that use a plasma display panel are flat panel display apparatuses that display an image using a gas discharge, and are expected to become one of the next generation of large flat panel display devices due to excellent display characteristics, such as high brightness and contrast, resistance to a latent image, large viewing angle, slimness, and large screen size, as compared to conventional cathode ray tubes (CRTs).

However, a conventional plasma display apparatus gives a double reflection of an image due to refraction caused by a material difference between a front substrate of a plasma display panel and a conventional tempered glass filter. Also, the conventional tempered glass filter must have a thickness of approximately 3 mm or more to resist external impact, and thereby increasing weight and cost of the conventional plasma display apparatus. Furthermore, the conventional tempered glass filter has a very complicated structure including various filters having various functions. Therefore, the process of manufacturing the conventional tempered glass filter is complicated and costly.

### SUMMARY OF THE INVENTION

The present invention provides a filter that can prevent a double image, can increase bright room contrast, has a reduced weight, and a plasma display apparatus having the filter. The present invention also provides a filter that is easier to manufacture and incurs lower manufacturing costs.

According to an aspect of the present invention, there is provided a filter including a base film, a plurality of light absorbing pattern units that are extended on a surface of the base film in predetermined intervals having a stripe shape, and blocking electromagnetic waves, and a reflection prevention layer covering the plurality of light absorbing pattern units.

The plurality of light absorbing pattern units may have a polygonal cross-section.

The plurality of light absorbing pattern units may be formed of metal oxide blocking electromagnetic waves.

A light reflection layer may be formed on a surface of the plurality of light absorbing pattern units facing the base film.

The reflection prevention layer may include a hard coating material for preventing scratches due to external impact.

The filter may further include a hard coating layer formed on the reflection prevention layer.

The filter may further include an adhesive layer formed on a lower surface of the filter to ensure adhesion between the filter and a display apparatus.

The adhesive layer includes a dye or a pigment.

The filter may further include a near infrared ray shielding layer formed on a side of the filter.

The filter may further include a color correction layer formed on a side of the filter.

According to another aspect of the present invention, there is provided a display apparatus including: a display panel displaying an image; a driving circuit substrate controlling the display panel by supplying a driving signal and power to the display panel; a chassis supporting the display panel and the driving circuit substrate; and the filter, which is attached on a front surface of the display panel.

The display panel may be a plasma display panel displaying an image using gas discharge.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view illustrating a configuration of a filter according to an embodiment of the present invention;

FIG. 2 is a cross-sectional view illustrating a configuration of a filter according to another embodiment of the present invention;

FIG. 3 is an exploded perspective view of a plasma display apparatus having a filter, according to an embodiment of the present invention; and

FIG. 4 is a cross-sectional view taken along a line IV-IV of the plasma display apparatus having a filter of FIG. 3, according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to one skilled in the art. In the drawings, the thickness of layers and region are exaggerated for clarity. Like reference numerals in the drawings denote like elements, and thus their description will be omitted.

FIG. 1 is a cross-sectional view illustrating a configuration of a filter 10 according to an embodiment of the present invention.

Referring to FIG. 1, the filter 10 includes a plurality of light absorbing pattern units 11, a base film 12, a reflection prevention layer 13 and an adhesive layer 14.

The light absorbing pattern units 11 of the filter 10 are formed on the base film 12. The light absorbing pattern units 11 may be distributed maintaining substantially the same distances apart from each other. The widths and the intervals of each of the light absorbing pattern units 11 are the same, and thereby maintaining an aperture ratio of 50%. The light absorbing pattern units 11 have a rectangular cross-section as illustrated in FIG. 1, but the present invention is not limited thereto. That is, the light absorbing pattern units 11 may have a polygonal cross-section such as triangular or trapezoidal cross-sections. The light absorbing pattern units 11 may be formed of a material having a high absorption of visible light, and may have a color of low brightness and chroma, in particular black. In particular, the light absorbing pattern units 11 may be formed of metal oxide blocking electromagnetic waves. The light absorbing pattern units 11 may be formed of metal oxide such as tin oxide, indium oxide, antimony oxide, zinc oxide, zirconium oxide, titan oxide, magnesium oxide, silicon oxide, aluminum oxide, metal alcoxide, indium tin oxide (ITO), or ATO. The light absorbing pattern units 11 are formed of the metal oxide, and thus the light absorbing pattern units 11 can block electromagnetic waves without using an electromagnetic wave shielding layer. When using the electromagnetic wave shielding layer, the light absorbing pattern units 11 can effectively block electromagnetic waves.

The metal oxide also blocks near infrared rays as well as electromagnetic waves. Accordingly, a malfunction of peripheral electronic devices due to the near infrared rays can be reduced.

The base film 12 of the filter is formed of a material that can transmit visible light, and, for convenience of transportation and attachment, may be formed of a flexible material.

The base film 12 is formed of the material that can transmit visible light, and directly attaches the filter 10 to a front surface of a plasma display panel. That is, the base film 12 may be formed of transparent material that easily adheres to material such as glass or plastic, preferably, a flexible material for convenience of transportation and attachment.

The base film 12 can be formed of polyethersulphone (PES), polyacrylate (PAR), polyetherimide (PEI), polyethyelenen napthalate (PEN), polyethyeleneterepthalate (PET), polyphenylene sulfide (PPS), polyallylate, polyimide, polycarbonate (PC), cellulose triacetate (TAC), or cellulose acetate propinonate (CAP), and preferably, PC, PET, TAC, or PEN.

The base film 12 can be colored to a predetermined color to control the transmittance of visible light to the whole filter 10. For example, when the base film 12 is a dark color, the transmittance of visible light is reduced. Furthermore, the color of visible light transmitting forward can be controlled. That is, the base film 12 can be completely colored to give a pleasant appearance to the user, or can be colored to increase the color purity of a plasma display apparatus that employs the filter 10 according to the present invention. Also, the color of the base film 12 can be patterned to correspond to each sub-pixel of a plasma display panel that employs the filter 10 according to the present invention. However, the present invention is not limited thereto, and the base film 12 can be colored in various ways for a variety of color correction purposes.

The base film 12 has a flat panel shape, and may have a thickness of 50 to 500 μm. However, as the thickness of the base film 12 is reduced, the scattering prevention effect of a plasma display panel is reduced, and as the thickness of the base film 12 is increased, the efficiency of a laminating process is reduced. Therefore, the base film 12 may also have a thickness in the range of 80 to 400 μm.

The reflection prevention layer 13 of the filter 10 diff-uses external incident light at the surface of the filter 10, and prevents the reflection of light from the outside of the filter 10 on the surface of the filter 10. When the reflection prevention layer 13 is formed on a conventional tempered glass filter, image clarity can be reduced due to an interface between the front substrate and the conventional tempered glass filter. Therefore, the reflection prevention layer 13 cannot be applied to the conventional tempered glass filter. However, the filter 10 of FIG. 1 according to the present invention does not reduce image clarity because the filter 10 is directly attached to the front surface of a plasma display panel. Accordingly, the reflection prevention layer 13 can be applied in the filter 10.

The filter 10 may include a hard coating material (not shown) inside the reflection prevention layer 13. A plasma display apparatus that uses the filter 10 may receive various external forces during operation, and thus has a high possibility of being scratched. Therefore, the hard coating material in the reflection prevention layer 13 can prevent the scratches on the filter 10 by external forces. The hard coating material of the filter 10 can be coated on the reflection prevention layer 13, or alternately, an additional hard coating layer (not shown) can further be formed on the reflection prevention layer 13.

The hard coating material of the filter 10 may include a polymer as a binder, for example, an acryl polymer, a urethane polymer, an epoxy polymer, a siloxane polymer, or an ultraviolet hardening resin such as oligomer. To increase hardness, a silica group filler can further be included in the hard coating material.

The reflection prevention layer 13 may have a thickness of 2 to 7 μm, a pencil hardness of 2 H to 3 H, and a haze of 1.0 to 3.0%, but the present invention is not limited thereto.

As indicated by the arrows in FIG. 1, the filter 10 transmits a portion of visible light (panel light) incident from the rear of the base film 12 straight towards the front of the base film 12, and reflects remaining portions of the panel light so as to diffuse the panel light. Also, visible light (exterior light) incident from the front of the base film 12 is absorbed or scattered by the light absorbing pattern unit 12 of the filter 10, that is, the exterior light is not reflected. In this way, the filter 10 greatly increases bright room contrast without greatly reducing the amount of visible light incident to the rear of the filter 10 from the plasma display apparatus.

An adhesive layer 14 of the filter 10 can further be formed on the lower surface of the filter 10 to ensure adhesion between the filter 10 and the front surface of a plasma display panel. To reduce a double image phenomenon, the adhesive layer 14 may have a predetermined refraction index difference with the plasma display panel, for example, not exceeding 1.0%.

The adhesive layer 14 may include a thermoplastic resin or ultra violet (UV) hardening resin, for example, an acrylate resin or a pressure sensitive adhesive (PSA), etc. The adhesive layer 14 can be formed by dip coating, air knife coating, roller coating, wire bar coating, gravure coating, etc.

The adhesive layer 14 may further include a compound that absorbs nearby infrared rays. The compound of the adhesive layer 14 can be a resin that includes copper atoms, a resin that includes a copper compound or a phosphorus compound, a resin that includes a copper compound or a thio-urea derivative, and a resin that includes a tungsten compound, or a cyanine compound.

The adhesive layer 14 can further include a dye or a pigment to provide color correction by blocking neon glow. The dye or pigment selectively absorbs visible light having a wavelength of 400 to 700 nm. In particular, when discharge occurs in the plasma display panel, undesirable visible light having a wavelength of approximately 585 nm is generated by neon discharge gas. To absorb the undesirable visible light, a pigment compound of cyanine, squaryl, azomethine, xanthine, oxonol, or azo group can be used. The pigment compound is dispersed in a fine grain state throughout the adhesive layer 14.

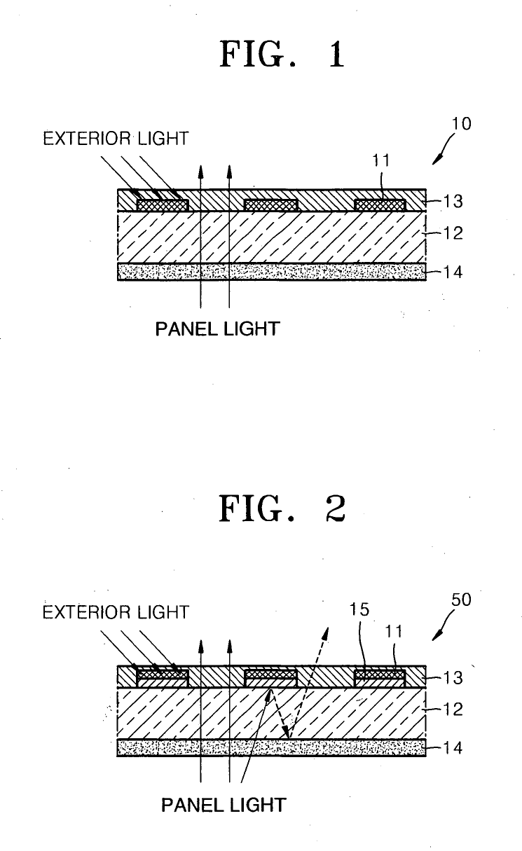

FIG. 2 is a cross-sectional view illustrating a configuration of a filter 50 according to another embodiment of the present invention.

Referring to FIG. 2, the filter 50 further includes a light reflection layer 15 located between a light absorbing pattern unit 11 and a base film 12 that is added to the filter 10 of FIG. 1. The light reflection layer 15 prevents panel light from being absorbed by the light absorbing pattern unit 11. That is, the panel light directed towards the light absorbing pattern unit 11 is reflected by the light reflection layer 15 disposed below the light absorbing pattern unit 11. A part of the panel light reflected as described above is reflected by the adhesive layer 14 to be emitted to the outside. Accordingly, the transmissivity of the panel light is improved. The light reflection layer 15 may be formed of a metal material selected from the group consisting of Ag, Ni, Cu, Cr, or the like.

The filter 50 may further optionally include a near infrared ray shielding layer (not shown) and/or a color correction layer (not shown). The color correction layer is used when the color purity of visible light incident from a plasma display apparatus to which the filter 50 is applied is low or if the color temperature must be corrected.

The filter 50 having the above structure can have a light transmittance greater than 30.0%, and a haze greater than 5.0%.

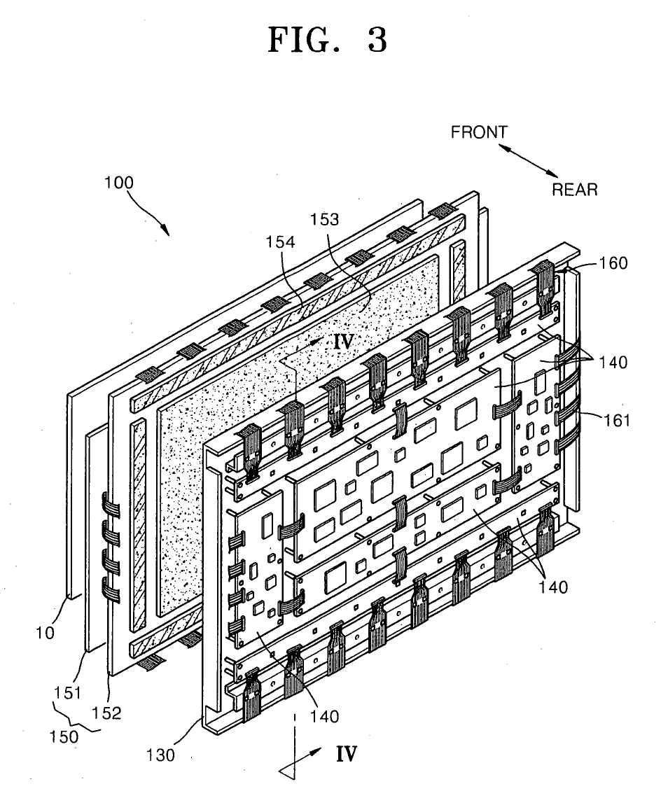

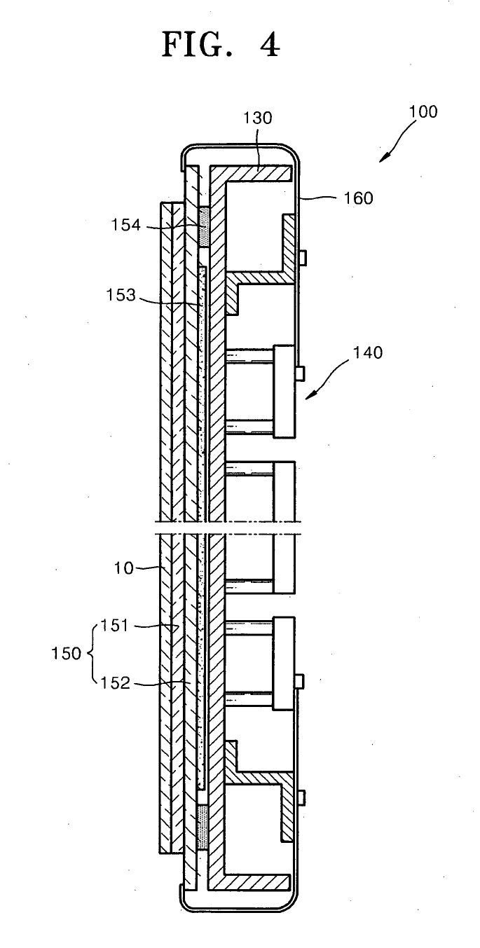

FIG. 3 is an exploded perspective view of a plasma display apparatus 100 having the filter 10 according to an embodiment of the present invention, and FIG. 4 is a cross-sectional view taken along a line IV-IV of the plasma display apparatus 100 having the filter 10 of FIG. 3, according to an embodiment of the present invention. The plasma display apparatus is only exemplary embodiment to which a filter according to the present invention can be applied. That is, a display apparatus, to which the filter can be applied, is not limited to the plasma display apparatus.

The plasma display apparatus 100 includes a plasma display panel 150, a chassis 130, and a circuit unit 140. The filter 10 according to an embodiment of the present invention is attached to the front surface of the plasma display panel 150. Adhesive elements such as a plurality of double-sided tape pieces 154 can be used for coupling the plasma display panel 150 to the chassis 130. A thermal conduction member 153 can be located between the chassis 130 and the plasma display panel 150 to dissipate heat generated by the plasma display panel 150 through the chassis 130.

The plasma display panel 150 displays images using gas discharge, and includes a front panel 151 and a rear panel 152 coupled to each other.

The filter 10 is attached completely to a front substrate of the plasma display panel 150 by surface contact using the adhesive layer 14 (See FIG. 1.) of the filter 10. The filter according to the present embodiment is not limited to the filter 10 of FIG. 1 and can be various shapes of filters to which an aspect of the present invention applies. Hence, also including the filter 50 of FIG. 2.

As such, electromagnetic waves generated by the plasma display panel 150 are blocked, and glare is reduced by the filter 10. Also, infrared rays or neon glow can be blocked. Furthermore, since the filter 10 is substantially directly attached to the front surface of the plasma display panel 150, a double image problem is resolved.

Also, the filter 10 has a lower weight than a conventional tempered glass filter, and accordingly, incurs lower costs.

The chassis 130 is located on the rear of the plasma display panel 150 to structurally support the plasma display panel 150. The chassis 130 may be formed of a metal having high strength such as aluminum or iron, or of plastic.

The thermal conduction member 153 is located between the plasma display panel 150 and the chassis 130. The plurality of double-sided tape pieces 154 are located on the rear panel 152 along the edges of the thermal conduction member 153. The double-sided tape pieces 154 fix the plasma display panel 150 to the chassis 130.

Also, the circuit unit 140 is located on the rear of the chassis 130. The circuit unit 140 includes circuits that drive the plasma display panel 150. The circuit unit 140 transmits electrical signals to the plasma display panel 150 via signal transmitting elements. The signal transmitting elements can be a flexible printed cable (FPC), a tape carrier package (TCP), or a chip on film (COP). According to the present embodiment, FPCs 161 that are used as the signal transmitting elements are located on left and right sides of the chassis 130, and TCPs 160 that are used as the signal transmitting elements are located on upper and lower sides of the chassis 130.

So far, the application of a filter according to the present invention has been explained with reference only to the plasma display apparatus, but the present invention is not limited to the plasma display apparatus. That is, the filter according to the present invention can be applied to the front surface of various display apparatuses.

A filter according the present invention and a plasma display apparatus having the filter can reduce a double image phenomenon since the filter is directly attached to the front surface of a plasma display panel, has a reduced weight and increased light transmittance, since the filter is formed using a relatively thin base film. In particular, since a plurality of light absorbing pattern units are uniformly distributed on one surface of base film, reflection of external light is greatly decreased and bright room contrast is greatly increased. Also, the manufacturing process of the plasma display apparatus having the filter is simple and cheap.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A filter comprising:
a base film;
a plurality of light absorbing pattern units that are extended on a surface of the base film to be spaced apart, and blocking electromagnetic waves; and
a reflection prevention layer covering the plurality of light absorbing pattern units.

2. The filter of claim 1, wherein the plurality of light absorbing pattern units have a polygonal cross-section.

3. The filter of claim 1, wherein the plurality of light absorbing pattern units are formed of metal oxide blocking electromagnetic waves.

4. The filter of claim 1, wherein the metal oxide comprises at least one selected from the group consisting of tin oxide, indium oxide, antimony oxide, zinc oxide, zirconium oxide, titan oxide, magnesium oxide, silicon oxide, aluminum oxide, metal alcoxide, indium tin oxide (ITO), or ATO.

5. The filter of claim 1, wherein a light reflection layer is formed on a surface of the plurality of light absorbing pattern units facing the base film.

6. The filter of claim 5, wherein the light reflection layer is located on a surface of the base film.

7. The filter of claim 1, further comprising an adhesive layer formed on a lower surface of the filter to have adhesion between the filter and a display apparatus.

8. The filter of claim 7, wherein the adhesive layer comprises a dye or a pigment.

9. A display apparatus comprising:
a display panel displaying an image; and
a filter attached on a front surface of the display panel, comprising:
a base film;
a plurality of light absorbing pattern units that are extended on a surface of the base film to be spaced apart, and blocking electromagnetic waves; and
a reflection prevention layer covering the plurality of light absorbing pattern units.

10. The display apparatus of claim 9, wherein the plurality of light absorbing pattern units have a polygonal cross-section.

11. The display apparatus of claim 9, wherein the plurality of light absorbing pattern units are formed of metal oxide blocking electromagnetic waves.

12. The display apparatus of claim 9, wherein the metal oxide comprises at least one selected from the group consisting of tin oxide, indium oxide, antimony oxide, zinc oxide, zirconium oxide, titan oxide, magnesium oxide, silicon oxide, aluminum oxide, metal alcoxide, indium tin oxide (ITO), or ATO.

13. The display apparatus of claim 9, wherein a light reflection layer is formed on a surface of the plurality of light absorbing pattern units facing the base film.

14. The display apparatus of claim 9, wherein the light reflection layer is located on a surface of the base film.

15. The display apparatus of claim 9, further comprising:
an adhesive layer formed on a lower surface of the filter to have adhesion between the filter and the display apparatus.

16. The display apparatus of claim 15, wherein the adhesive layer comprises a dye or a pigment.
